(19) United States
(12) Patent Application Publication
(10) Pub. No.: US 2007/0199041 A1
(43) Pub. Date: Aug. 23, 2007

(54) Video systems and methods of using the same

(75) Inventors: Roland Noll, San Antonio, TX (US); Mary McCarthy, San Antonio, TX (US); Scott A. Pettit, San Antonio, TX (US); Ross Cox, Cumming, GA (US); Anthony A. Haeuser, Aurora, IL (US); Christopher Lee, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/360,746

(22) Filed: Feb. 23, 2006

(51) Int. Cl. H04N 7/16

(52) U.S. Cl. 725/135; 725/136

(57) ABSTRACT

A television content provider can reserve and use a television channel can be used to provide interactive content to a user device. Unlike conventional broadcast channels, a user at the user device may view content to an extent (length, depth, or both) that the user desires. The user can pick and choose content to view, may drill down to whatever level of detail that the user desires, contact an originating source of the content, interact with the content in another manner, or the like. Unlike the Internet, the content can be customized for transmission over a television channel, which may allow higher quality and potentially a larger array of content than may otherwise be provided over the Internet. The transmission may be performed over a private network, so that security concerns are reduced.

### BACKGROUND

1. Field of the Disclosure

The present disclosure relates to methods and systems, and more particularly to video systems, methods of using the video systems, and data processing readable media used within or in conjunction with the video systems.

2. Description of the Related Art

Video systems are being designed that can display media from a variety of sources. Interactive television is an example of such a video system. Conventional interactive television includes a unidirectional broadcast stream that is received by a user device. A user can activate a link that appears within a television program or advertisement from the broadcast stream, which in turn will redirect the user device to the corresponding web site on the Internet. At this point, the user may continue to browse the Internet, just as if the user were at a conventional personal computer. The Internet can have nearly an infinite number of domain names that can be used. Thus, the number of content providers using the Internet is almost limitless.

The Internet is not well suited for some content, and particularly for content that is better viewed only at relatively high transmission rates. For example, a connection to the Internet can vary from a plain old telephone system (“POTS”) line that may have a transmission rate of about 28 to 54 KB/second, to a conventional broadband connection that may have a transmission rate of 128 KB/second to 1.5 MB/second, to a T1 or faster connection that may have a transmission rate of 10 MB/second. The different transmission rates can force a content provider to make compromises in order to allow the content to be seen by many user devices that have different connections.

The Internet is a public network and has security issues. Client computers and other user devices connected to the Internet are subject to attacks, risk becoming infected with worms, viruses, or other undesirable code that may be transmitted to the client computers, other adverse consequences, or any combination thereof. Firewalls, anti-virus software, or other suitable security software may need to be installed on the client computers. Even if such security measures are implemented, they typically need to be updated to keep pace with the increasing sophistication of the worms, viruses, etc. Thus, use of the Internet can impose additional time and costs to keep client computers resistant to attacks from worms, viruses, or the like.

### BRIEF DESCRIPTION OF THE DRAWINGS

FIG. 1 includes a general diagram of an Internet Protocol television system that may be used to provide video content.

FIG. 2 includes a block diagram illustrating modules and their interaction between a data processing system and content sources and user devices.

FIG. 3 includes a flow diagram of an exemplary method of receiving content at a user device.

FIG. 4 includes a flow diagram of an exemplary method of receiving content from content providers and providing content to user devices.

FIG. 5 includes a flow diagram of an exemplary method involving subscription video newsletters.

FIG. 6 includes a diagram of an illustrative embodiment of a general computer system.

Skilled artisans will appreciate that elements in the figures are illustrated for simplicity and clarity and have not necessarily been drawn to scale.

### DETAILED DESCRIPTION

A television content provider can reserve and use a television channel to provide interactive content to a user device. Unlike conventional broadcast channels, a user at the user device may view content to an extent (length, depth, or both) that the user desires. The user can pick and choose content to view, may drill down to whatever level of detail that the user desires, contact an originating source of the content, interact with the content in another manner, or the like. Unlike the Internet, the content can be customized for transmission over a television channel, which may allow higher quality and potentially a larger array of content than may otherwise be provided over the Internet. The transmission may be performed over a private network, so that security concerns are reduced.

In a first aspect, a method of using a video system can include receiving broadcast content via data packets over a first television channel. The method can also include receiving interactive content via data packets over a second television channel that is different from the first television channel.

In a second aspect, a data processing system readable medium can have data embodied within the data processing system readable medium. The data can include an instruction to send broadcast content via data packets over a first television channel to a user device. The data can also include an instruction to send the interactive content via data packets over a second television channel to the user device, wherein the second television channel is different from the first television channel.

In a third aspect, a data processing system can include a request receiving module. The data processing system can also include an interactive content transmission module adapted to transmit interactive content over a television channel to a user device, wherein the interactive content includes data packets. The data processing system can further include a video-on-demand server coupled to the interactive content transmission module. The video-on-demand server can be configured to retrieve and send the interactive content to the interactive content transmission module, and the interactive content may be associated with the request.

As used herein, the term “interactive content” is intended to mean content that includes a user-selectable element that is embedded within the content, and wherein the user-selectable element is associated with a request to modify the content or obtain new or different content.

The terms “comprises,” “comprising,” “includes,” “including,” “has,” “having” or any other variation thereof, are intended to cover a non-exclusive inclusion. For example, a process, method, article, or apparatus that comprises a list of elements is not limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of “a” or “an” are employed to describe one or more articles to which “a” or “an” refers. Therefore, the description should be read to include at least one whenever “a” or “an” is used, and the singular also includes the plural unless it is clear that the contrary is meant otherwise.

Unless stated otherwise, any combination of parts of a system may be bi-directionally or uni-directionally coupled to each other, even though a figure may illustrate only a single-headed arrow or a double-headed arrow. Arrows within the drawing are illustrated, as a matter of convenience, to show a principal information, data, or signal flow within the system or between the system and one or more components outside the system, one or more modules outside the system, another system, or any combination thereof in accordance with an embodiment. Coupling should be construed to include a direct electrical connection in one embodiment and alternatively, may include any one or more of an intervening switch, resistor, capacitor, inductor, router, firewall, network fabric or the like between any combination of one or more components, one or more devices, or one or more modules.

Unless otherwise defined, technical and scientific terms used herein have the same meaning as commonly understood by one of ordinary skill in the art. In addition, the methods and examples disclosed are illustrative only and not intended to be limiting.

Interactive content and examples of interactive content are addressed before describing a video system. Interactive content can include a user-selectable element that is located within the content itself. When the interactive content is being used at a user device, the user-selectable element may allow a user to modify the content being sent from a data processing system of a television content service provider to the user device. In one embodiment, the user-selectable element may be an object that a user may activate using a remote control or other input device at a user device. In a particular embodiment, when activated, the object may cause a request to be generated at the user device and be sent from the user device to the data processing system of the television content service provider. The request may be to modify the existing content or to send additional or other content from the television content service provider over the current television channel to the user device.

Interactive content differs from broadcast content. Broadcast content can include a hyperlink that may be displayed during a commercial. When activated, the content corresponding to the hyperlink would come from the Internet and is not transmitted over the same television channel as the broadcast content.

Video systems that can be used with the methods described herein are address. A video system can include an Internet Protocol Television (“IPTV”) system. The IPTV system is an example of a video system and is used to illustrate and not limit the concepts described herein. After reading this specification, skilled artisans will appreciate that other video systems, such as an analog or other digital video system may be used.

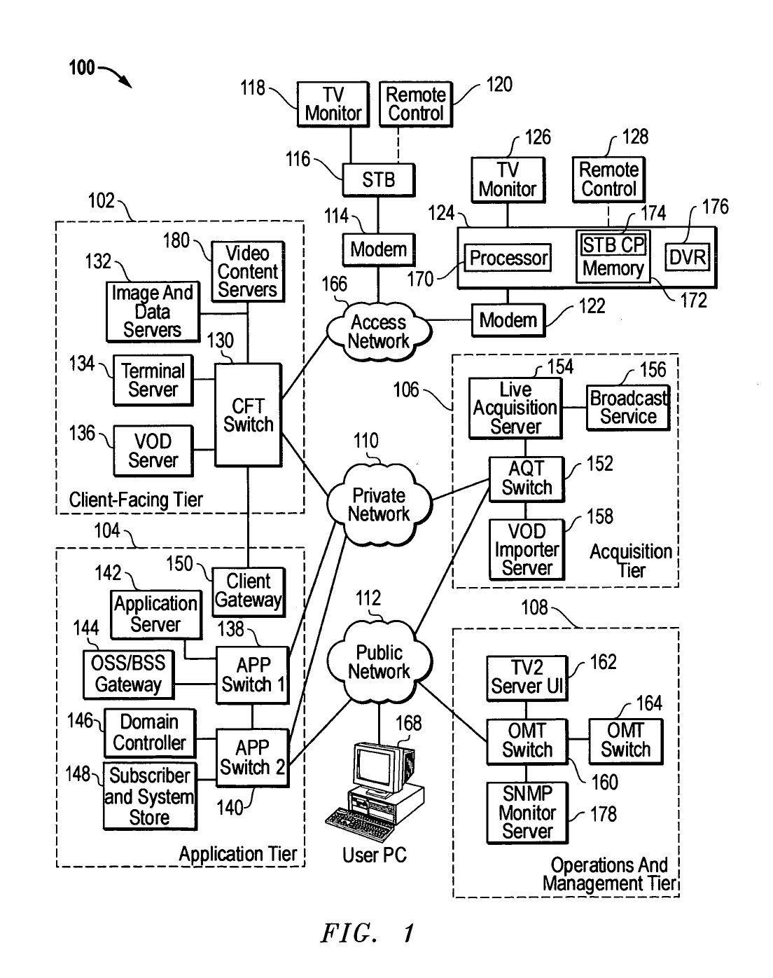

Referring to FIG. 1, an illustrative embodiment of an IPTV system that may be used to provide video content is illustrated and is generally designated 100. As shown, the IPTV system 100 can include a client-facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102. More, fewer, or different tiers may be used in other embodiments.

As illustrated in FIG. 1, the client-facing tier 102 can communicate with user equipment via a private access network 166, such as an IPTV access network. In an illustrative embodiment, modems, such as a first modem 114 and a second modem 122 can be coupled to the private access network 166. The client-facing tier 102 can communicate with a first representative set-top box (“STB”) device 116 via the first modem 114 and with a second representative STB device 124 via the second modem 122. The client-facing tier 102 can communicate with a large number of STB devices, such as the representative STB devices 116, 124, over a wide geographic area, such as a regional area, a metropolitan area, a viewing area, a designated market area or any other suitable geographic area, market area, or user or customer group that can be supported by networking the client-facing tier 102 to numerous STB devices. In an illustrative embodiment, the client-facing tier, or any portion thereof, can be included at a video head-end office.

In a particular embodiment, the client-facing tier 102 can be coupled to the modems 114, 122 via fiber optic cables. Alternatively, the modems 114 and 122 can be digital subscriber line (“DSL”) modems that are coupled to one or more network nodes via twisted pairs, and the client-facing tier 102 can be coupled to the network nodes via fiber-optic cables. Each STB device 116, 124 can process data received via the private access network 166, via an IPTV software platform, such as Microsoft® TV IPTV Edition.

Additionally, the first STB device 116 can be coupled to a first external display device, such as a first television monitor 118, and the second STB device 124 can be coupled to a second external display device, such as a second television monitor 126. Moreover, the first STB device 116 can communicate with a first remote control 120, and the second STB device can communicate with a second remote control 128. A television tuner (not illustrated) may lie within the first STB device 116, the first television monitor 118, the second STB device 124, the second television monitor 126, another suitable monitor or device (e.g., the modem 114 or 116), or any combination thereof. The television tuner can be National Television System Committee (“NTSC”) tuner, an Advanced Television System Committee (“ATSC”), another suitable analog or digital tuner, or any combination thereof. A signal for a television channel can pass through the tuner before the content is displayed on a monitor.

In an exemplary, non-limiting embodiment, each STB device 116, 124 can receive video content, which may include video and audio portions, from the client-facing tier 102 via the private access network 166. The STB devices 116, 124 can transmit the video content to an external display device, such as the television monitors 118, 126. Further, the STB devices 116, 124 can each include a STB processor, such as STB processor 170, and a STB memory device, such as STB memory 172, which is accessible to the STB processor 170. In one embodiment, a computer program, such as the STB computer program 174, can be embedded within the STB memory device 172. Each STB device 116, 124 can also include a video content storage module, such as a digital video recorder (“DVR”) 176. In a particular embodiment, the STB devices 116, 124 can communicate commands received from the remote control devices 120, 128 to the client-facing tier 102 via the private access network 166.

In an illustrative embodiment, the client-facing tier 102 can include a client-facing tier (“CFT”) switch 130 that manages communication between the client-facing tier 102 and the private access network 166 and between the client-facing tier 102 and the private network 110. As shown, the CFT switch 130 is coupled to one or more image and data servers 132 that store still images associated with programs of various IPTV channels. The image and data servers 132 can also store data related to various channels, e.g., types of data related to the channels and to programs or video content displayed via the channels. In an illustrative embodiment, the image and data servers 132 can be a cluster of servers, each of which can store still images, channel and program-related data, or any combination thereof. The CFT switch 130 can also be coupled to a terminal server 134 that provides terminal devices with a connection point to the private network 110. In a particular embodiment, the CFT switch 130 can also be coupled to a video-on-demand (“VOD”) server 136 that stores or provides VOD content imported by the IPTV system 100. The client-facing tier 102 can also include one or more video content servers 180 that transmit video content requested by viewers via their STB devices 116, 124. In an illustrative, non-limiting embodiment, the video content servers 180 can include one or more multicast servers.

As illustrated in FIG. 1, the application tier 104 can communicate with both the private network 110 and the public network 112. The application tier 104 can include a first application tier (“APP”) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the STB devices 116, 124 via the private access network 166, which enable the STB devices 116, 124 to provide functions, such as display, messaging, processing of IPTV data and VOD material, etc. In a particular embodiment, the operation systems and support (“OSS”)/billing systems and support (“BSS”) or OSS/BSS gateway 144 includes OSS data, BSS data, or any combination thereof. In one embodiment, the OSS/BSS gateway 144 can provide or restrict access to an OSS/BSS server 164 that stores operations and billing systems data.

Further, the second APP switch 140 can be coupled to a domain controller 146 that provides web access, for example, to users via the public network 112. For example, the domain controller 146 can provide remote web access to IPTV account information via the public network 112, which users can access using their personal computers 168. The second APP switch 140 can be coupled to a user and system store 148 that includes account information, such as account information that is associated with users who access the IPTV system 100 via the private network 110 or the public network 112. In a particular embodiment, the application tier 104 can also include a client gateway 150 that communicates data directly with the client-facing tier 102. In this embodiment, the client gateway 150 can be coupled directly to the CFT switch 130. The client gateway 150 can provide user access to the private network 110 and the tiers coupled thereto.

In a particular embodiment, the STB devices 116, 124 can access the IPTV system 100 via the private access network 166, using information received from the client gateway 150. In this embodiment, the private access network 166 can provide security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen STB devices from accessing the private network 110, by denying access to these devices beyond the private access network 166.

For example, when the first representative STB device 116 accesses the IPTV system 100 via the private access network 166, the client gateway 150 can verify user information by communicating with the user and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query across the first APP switch 138, to the second APP switch 140, and the second APP switch 140 can communicate the query across the public network 112 to the OSS/BSS server 164. After the client gateway 150 confirms user information, billing information, or both user and billing information, the client gateway 150 can allow the STB device 116 access to IPTV content and VOD content. If the client gateway 150 cannot verify user information for the STB device 116, e.g., because it is connected to an unauthorized twisted pair, the client gateway 150 can block transmissions to and from the STB device 116 beyond the private access network 166.

As indicated in FIG. 1, the acquisition tier 106 includes an acquisition tier (“AQT”) switch 152 that communicates with the private network 110. The AQT switch 152 can also communicate with the operations and management tier 108 via the public network 112. In a particular embodiment, the AQT switch 152 can be coupled to a live acquisition server 154 that receives television or movie content, for example, from a broadcast service 156. In a particular embodiment during operation of the IPTV system, the live acquisition server 154 can acquire television or movie content. The live acquisition server 154 can transmit the television or movie content to the AQT switch 152, and the AQT switch 152 can transmit the television or movie content to the CFT switch 130 via the private network 110.

Further, the television or movie content can be transmitted to the video content servers 180, where it can be encoded, formatted, stored, or otherwise manipulated and prepared for communication to the STB devices 116, 124. The CFT switch 130 can communicate the television or movie content to the modems 114, 122 via the private access network 166. The STB devices 116, 124 can receive the television or movie content via the modems 114, 122, and can transmit the television or movie content to the television monitors 118, 126. In an illustrative embodiment, video or audio portions of the television or movie content can be streamed to the STB devices 116, 124.

Further, the AQT switch can be coupled to a VOD importer server 158 that stores television or movie content received at the acquisition tier 106 and communicates the stored content to the VOD server 136 at the client-facing tier 102 via the private network 110. Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When user issue requests for VOD content via the STB devices 116, 124, the requests can be transmitted over the private access network 166 to the VOD server 136, via the CFT switch 130. Upon receiving such requests, the VOD server 136 can retrieve the requested VOD content and transmit the content to the STB devices 116,124 across the private access network 166, via the CFT switch 130. The STB devices 116, 124 can transmit the VOD content to the television monitors 118, 126. In an illustrative embodiment, video or audio portions of VOD content can be streamed to the STB devices 116, 124.

FIG. 1 further illustrates that the operations and management tier 108 can include an operations and management tier (“OMT”) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (“SNMP”) monitor 170 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (“PC”) 168 coupled to the public network 112.

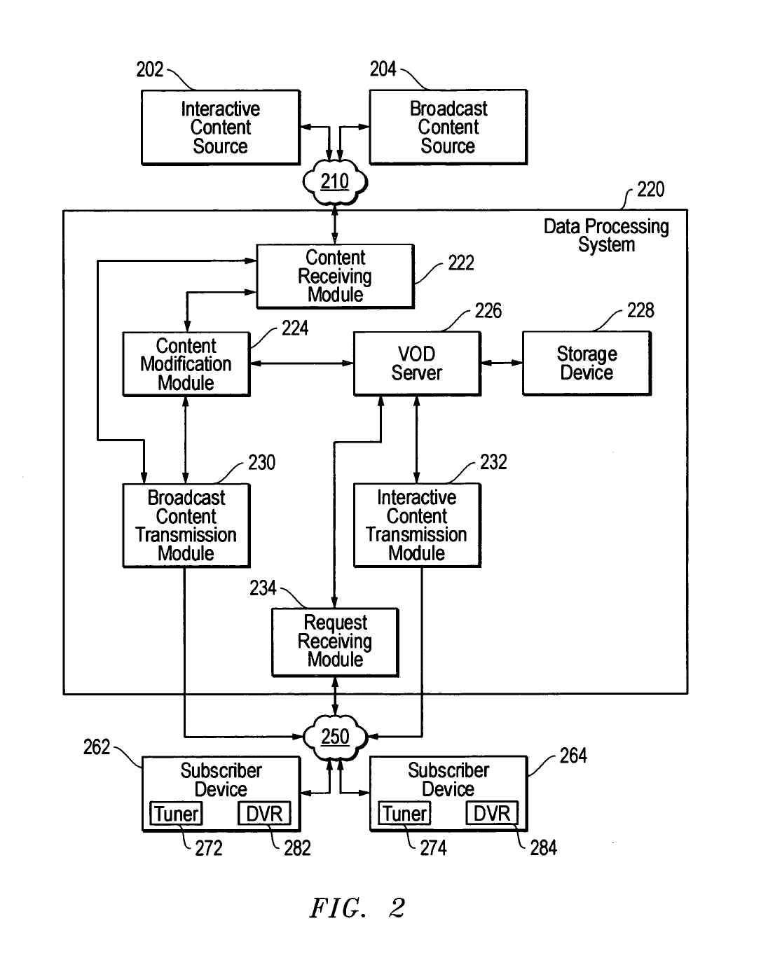

FIG. 2 includes a general diagram of a video system that includes a data processing system 220. In one embodiment, the data processing system 220 may lie within the client-facing tier 102, the application tier 104, the acquisition tier 106, or another tier within the IPTV system 100. The data processing system 220 can be bi-directionally coupled to an interactive content source 202 and a broadcast content source 204 via a network 210. The network 210 can be a public network, such as the Internet, or a private network.

Relationships between devices outside the data processing system 220 and relationships between modules within the data processing system 220 are addressed before describing the modules in more detail. Each of the modules may include hardware, software, firmware, or any combination thereof to achieve the functionality as described herein.

The data processing system 220 can include a content receiving module 222 that can be bi-directionally coupled to the network 210, a content modification module 224, and a broadcast content module 230. The content modification module 222 can be bi-directionally coupled to a VOD server 226 and the broadcast content transmission module 228. The VOD server 226 can be bi-directionally coupled to a storage device 228, an interactive content transmission module 232, and a request receiving module 234. The broadcast content transmission module 230, the interactive content transmission module 232, and the request receiving module 234 can be bi-directionally coupled to a network 250. User devices 262 and 264 can be bi-directionally coupled to the network 250.

The interactive content source 202 may provide nearly any interactive content to the data processing system 220. The interactive content can include substantially promotional content associated with a product, a service, or any combination thereof. For example, the interactive content source 202 can be associated with a commercial entity. In another embodiment, the interactive content can include educational content regarding a topic. For example, the interactive content source 202 may be an educational entity (a school district, a university, etc.), a public television network (e.g., the Public Broadcasting Service, a public-access station, etc.), a non-profit organization (e.g., American Cancer Society, Red Cross, etc.), or any combination thereof. The interactive content may be organized with a hierarchy of different levels.

The broadcast content source 202 may provide nearly any broadcast content to the data processing system 220. The broadcast content can include a movie, an episode of television series, an artistic performance, a sporting event, other suitable entertainment or educational information, or any combination thereof. The broadcast content may come from a source, such as FOX, National Broadcasting System, Home Box Office, other suitable television network, or any combination thereof. The broadcast content is typically organized into a single level, and therefore, does not have the hierarchy of different levels that the interactive content has.

The networks 210 and 250 may be public networks, private networks, or any combination thereof. In a particular embodiment, the network 210 can be a public network, and the network 250 can be a private network.

The content receiving module 222 can receive interactive content from the interactive content source 202, broadcast content from the broadcast content source 204, or any combination thereof, and route the content to the content modification module 224 or to the broadcast content transmission module 230. In one embodiment, substantially all of the interactive content is routed to the content modification module 224, and broadcast content may or may not be routed to the content modification module 224.

The content modification module 224 can be configured to reformat or otherwise change the content so that the interactive content is better tailored for transmission over a television channel. The content modification can include changing the content to achieve a higher image quality (e.g., higher resolution), a higher transmission rate or bandwidth, or the like. The quality of service associated with transmissions from the data processing system 220 to a user device 262 or 264 can be set by the service provider and improve the user experience when interacting with interactive content or viewing broadcast content over a television channel. After modification, the modified content (that may include broadcast content or interactive content) can be sent to the broadcast content transmission module 230 or the VOD server 226.

The VOD server 226 can receive content from the content modification module 224. The VOD server 226 can send content to the storage device 228 or to the interactive transmission module 226. The storage device 228 can include a hard disk, a database, a storage network, or any combination thereof. The storage device 228 can store interactive content in accordance with the hierarchy of different levels (e.g., folders, sub-folders, other data organizations, etc.). In another embodiment, the storage device 228 may reside outside and be coupled to the data processing system 220. The VOD server 226 can receive requests for content, such as interactive content, from the request receiving module 234 that may have originated from a user device 262 or 264. The VOD server 226 may search a local cache (not illustrated) to determine if the requested content is in the local cache. If not, the VOD server 226 may retrieve the content via the storage device 228. After retrieval, the content can be sent from the VOD server 226 to the interactive content transmission module 232, which can direct the content to the user device 262 or 264 that requested the content.

The interactive content transmission module 232 can be configured to transmit interactive content over a television channel to the user device 262 or 264. Address or other associated information from the request may be routed from the request receiving module 234 to the VOD server 226 and to the interactive content transmission module 232, so that the interactive content transmission module 232 can send the interactive content to the user device 262 or 264 that requested the content.

The broadcast content transmission module 230 can transmit broadcast content to the user device 262 and 264. The broadcast content may or may not be modified by the content modification module 224 before the broadcast content is transmitted to the user devices 262 and 264. In one embodiment, broadcast content transmission module 230 can transmit independently from the interactive content transmission module 232, and vice versa.

Each of the user devices 262 and 264 can include a television tuner 272, 274, a DVR 282, 284, a modem, an STB device, a television monitor, a remote control, a keyboard, or other input device, or any combination thereof as described herein (e.g., as illustrated in FIG. 1). In a particular embodiment, a user can input a request for information using a remote control that is coupled to the STB device. The STB device can send the request and address information to a modem, which in turn can send the request and address to the request receiving module 234 via network 250 in FIG. 2.

After reading this specification, skilled artisans will appreciate that many modifications are possible. Different coupling of modules within the data processing system 220 can be used. In one embodiment, the broadcast content transmission module 230 may be coupled to the VOD server 226. In another embodiment, the content modification module 224 can be coupled to the interactive content transmission module 232 without having to go through the VOD server 226. The request receiving module 234 may be coupled to the broadcast content transmission module 230, the interactive content transmission module 232, or both. Although not illustrated, switches, routers, other components, connections or memories may reside in or be coupled to the data processing system 220

Additional content sources and user devices (not illustrated) may be coupled to the data processing system 220. In one embodiment, a plurality of different broadcast content sources, a plurality of different interactive content sources, or the like may be coupled to the data processing system 220. Similarly, more than two user devices can be coupled to the data processing system 220. Any combination of users can view substantially the same broadcast content, substantially the same interactive content, different broadcast content, or different interactive content substantially simultaneously at any point in time.

Portions of the methods and functions of modules described herein may be implemented in suitable software code or other data for carrying out the methods described. In one embodiment, computer-executable instructions may be lines of assembly code or compiled C⁺⁺, Java, or other language code. In another embodiment, the code may be contained on a data storage device, such as a hard disk, magnetic tape, floppy diskette, optical storage device, networked storage device(s), or other appropriate data processing system readable medium or storage device.

Functions performed by any one or more of the modules may be combined with one or more other modules within the data processing system 220. For example, the content receiving module 222 and the content modification module 224 may be combined into a single module. In still another embodiment, a module or device illustrated as residing in the data processing system 220 may reside outside the data processing system. For example, in the video system, the VOD server 226 and storage device 226 may reside within or outside of the data processing system 220. Also, any single module may be embedded within a plurality of integrated circuits, chip sets, circuit boards, or the like. Additionally, a software program or its software components with such code may be embodied in more than one data processing system readable medium in more than one computer or other item having a controller or a processor.

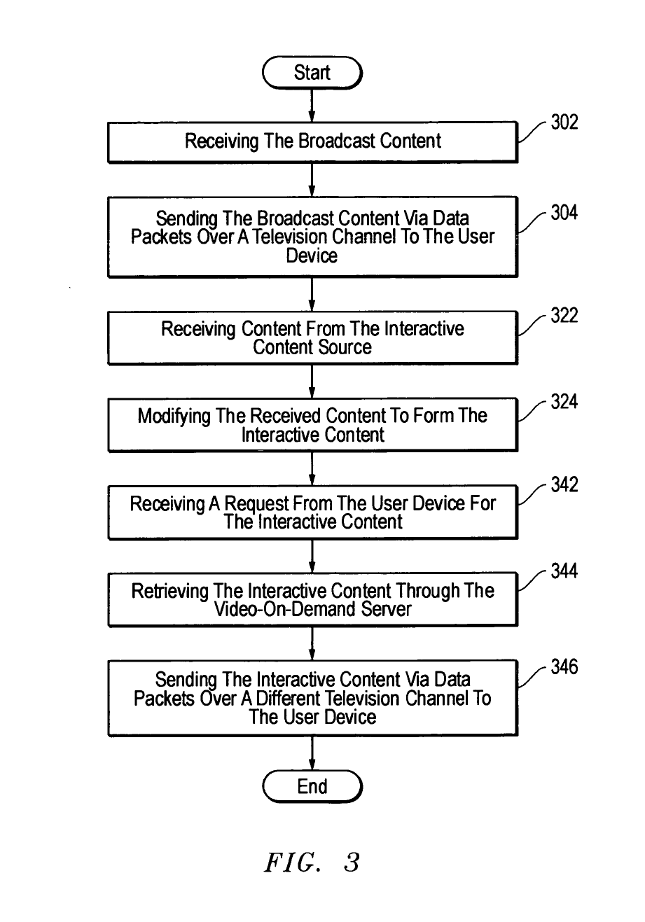

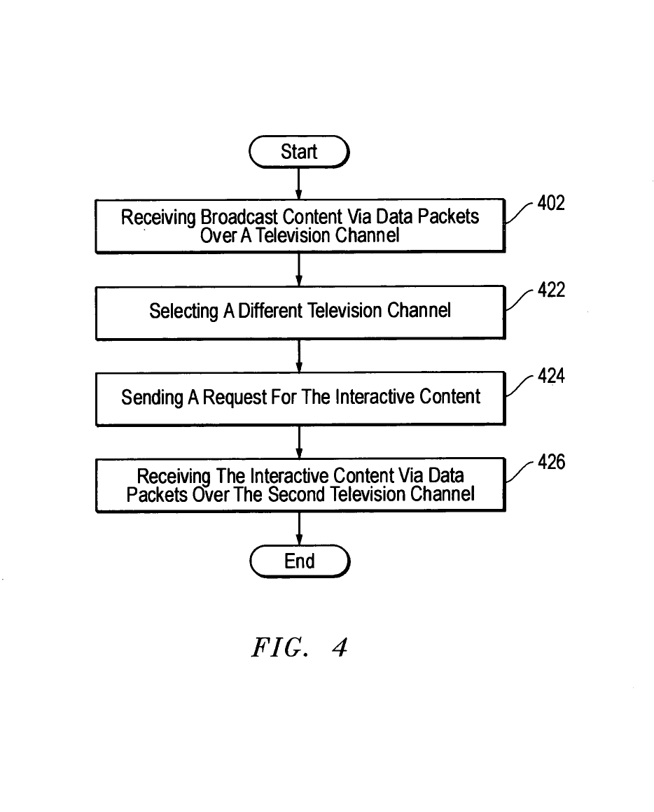

Methods of using the video system are illustrated and described with respect to FIGS. 3 and 4. FIG. 3 is directed to the methods from the perspective of the data processing system 220, and FIG. 4 is directed to the methods from the perspective of the user device 262 or 264. References may be made to FIG. 2 when describing the methods to improve understanding of the methods and associated parts of the video system.

The method can include receiving broadcast content, at block 302 in FIG. 3. The broadcast content can be received by the data processing system 220 at the content receiving module 222. The broadcast content received may have been sent from the broadcast content source 204. The broadcast content can be sent from the content receiving module 222 to the broadcast content transmission module 230. The broadcast content may or may not be modified at the content modification module 224 before being received at the broadcast content transmission module 230.

The method can also include sending the broadcast content via data packets over a television channel to the user device, at block 304 in FIG. 3, and receiving broadcast content via data packets over a television channel, at block 402 in FIG. 4. The broadcast content transmission module 230 can convert the broadcast content into data packets, if this has not already occurred. The broadcast content can then be broadcast over a television channel. In one embodiment, the broadcast content can be broadcast substantially in real time at a predetermined time. The broadcast content will be received by a user device 262 or 264 that is tuned to the television channel. The broadcast content may be decoded or otherwise processed using the tuner 272 or 274 and displayed at the television monitor of the user device 262 or 264, stored within a digital video recorder 282 or 284, or any combination thereof.

The method can further include receiving content from the interactive content source, at block 322 of FIG. 3, and modifying the received content to form interactive content, at block 324. The content from the interactive content source 202 in FIG. 2 may or may not be of sufficient quality for transmission over a television channel. The content from the interactive content source 202 can be routed through the content receiving module 222 to the content modification module 224. In one embodiment, the content modification module 224 may change the content so that it has a different data format, a different transmission quality, a different display quality, or any combination thereof. In a particular embodiment, the interactive content source 202 may provide content that is normally transmitted over the Internet. The Internet has unpredictable delays, drops packets or frames, needs to accommodate users with a wide variety of access rates, and other problems. Thus, the content would not be optimized for transmission over a television channel. By modifying the content, the interactive content can be tailored to transmission over a television channel to allow more uniformity and higher quality of service as compared to the Internet. The interactive content can be forwarded to the VOD server 226 where it can store the interactive content within the storage device 228. The actions as recited within blocks 322 and 324 may be performed asynchronously with respect to the broadcast content.

The method can still further include selecting a different television channel, at block 422 in FIG. 4. The user may be viewing broadcast content at the television monitor of the user device 262 or 264. The broadcast content may include an icon, a tile, or other indicator to let the user switch to a television channel associated with the interactive content. In a particular embodiment, the user may be viewing a commercial that is part of the broadcast content. The icon, tile, or other indicator may appear on the television monitor during or just after the commercial. The user can use the remote control to activate the icon, tile, or other indicator, which will redirect the STB device to change to the channel associated with the icon, tile, or other indicator. For example, the commercial may be for an automobile from an automobile manufacturer. When the icon, tile, or other indicator is activated, the STB device changes to another television channel associated with interactive content that is associated with the automobile manufacturer.

The television channel associated with the interactive active content can allow a user to read, hear, view, or otherwise experience a wide array of content as the user desires. The interactive content can include static information (e.g., specifications of the automobile, locations of dealers, etc.), audible segments (e.g., audio segments from radio commercials, examples of exhaust sounds with different exhaust systems, etc.), video segments (e.g., pictures of the automobile, motion pictures of the automobile while operating, etc.), other experiences (e.g., video segment of the automobile from the driver's seat while the automobile is in motion, video segment from a trailing automobile, etc.), or any combination thereof. The user can explore the interactive content at whatever depth or whatever rate that the user desires.

The method can include sending a request for the interactive content, at block 424 in FIG. 4, and receiving a request from the user device for interactive content, at block 342 in FIG. 3. The request may be sent from the user device 262 or 264 to the request receiving module 234 in FIG. 2. The request can include metadata, such as a network address associated with the user device 262 or 264 to ensure the requested content is returned to the user device making the request. The request, including the network address, can be sent to the VOD server 226.

The method can also include retrieving the interactive content through the VOD server, at block 344 of FIG. 3. The VOD server 226 in FIG. 2 may determine whether the content already resides within a local cache within the VOD server 226. If the interactive content associated with the request is within the local cache, a processor within the VOD server 226 can retrieve the interactive content from the local cache. The local cache allows quicker access to frequently or recently requested content. If the interactive content associated with the request is not in the local cache, the VOD server 226 can retrieve the interactive content associated with the request from the storage device 228. The interactive content associated with the request and the network address of the user device 262 or 264 making the request can be sent from the VOD server 226 to the interactive content transmission module 232.

The method can further include sending the interactive content via data packets over a different television channel to the user device, at block 344 in FIG. 3. Sending the interactive content can be performed in response to receiving the request from the user device 262 or 264 for the interactive content. If the interactive content is not in data packets, the interactive content transmission module 232 can convert the interactive content to data packets. The interactive content transmission module 232 can generate metadata, including the network address of the user device 262 or 264 that will be associated with the interactive content. The interactive content is sent from the interactive content transmission module 232 to the user device 262 or 264 via the network 250.

The request and interactive content associated with the request can vary. In one embodiment, the request includes a search string, and the interactive content includes information associated with the search string. In another embodiment, the request includes a request for a video segment associated with a product or service, and the interactive content includes the video segment. In still another embodiment, the request includes information associated with a product configuration, and the interactive content includes a video image associated with a product having the product configuration. In yet another embodiment, the request includes a request to schedule a test of a product or service, and the interactive content includes a confirmation associated with the test. In a further embodiment, the request can include any combination of the foregoing requests, and the interactive content can include any combination of the foregoing interactive content. In a non-limiting example, a user at the user device 262 or 264 could watch short films associated with a particular automobile, schedule a test drive of that automobile, peruse color schemes or options available, make another request for information, or any combination thereof. After reading this specification, skilled artisans will appreciate that other types of requests and other types of interactive content may be used.

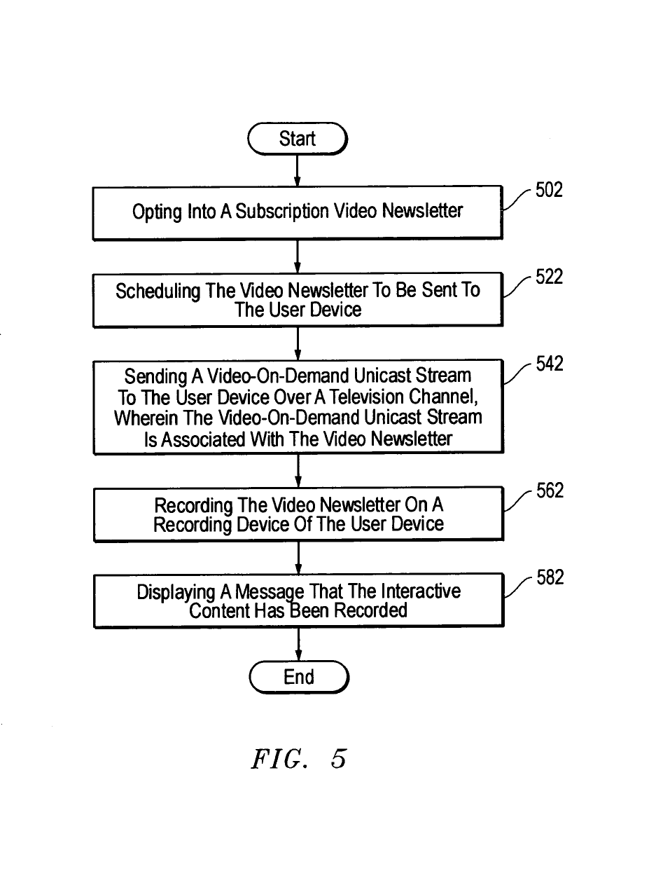

The video system described herein may also be used with respect to subscription video newsletters. The subscription video newsletters can be part of or include interactive content. The method can include opting into a subscription video newsletter, at block 502 in FIG. 5. A user can use the remote control or another input device of the user device 262 or 264 to input information into the user device 262 or 264. The user can be added to a subscription list for the subscription video newsletters. The information regarding the user, such as the name, network address for the user device 262 or 264, can be received by the request receiving module 234 and forwarded to the VOD server 226. The VOD server 226 can store the subscription list within local memory within the VOD server 226 or store the subscription list within the storage device 228. When a video newsletter associated the subscription video newsletter is received by the data processing system 220, the subscription list will be used to send the video newsletter from the data processing system 220 that will be automatically received by the user device 262 or 264.

A video newsletter, that is part of the subscription video newsletters, may be sent from the interactive content source 202 to the data processing system 220. The video newsletter, which is a type of a communication, may be a brochure or other information. The video newsletter can be received by the content receiving module 222 at the data processing system 220 and forwarded to the content modification module 224, modified by the content modification module 224 and forwarded to the VOD server 226, and stored within the storage device 228. The video newsletter may include metadata that has a targeted earliest release date and time.

The method can also include scheduling a video newsletter to be sent to the user device, at block 522. The VOD server 226 can use the metadata in order to perform the schedule. The VOD server 226 may access the subscription list for the subscription video newsletter to determine network addresses to which the video newsletter will be sent. The VOD server 226 may optionally use other rules in determine the schedule. The rules may take into account the number of network addresses to which the video newsletter will be sent, server or network capacity, peak or off-peak times of usage, a geographic consideration (e.g., country, time zone, or the like), another suitable parameter, or any combination thereof. After reading this specification, skilled artisans will be able to schedule the sending of the video newsletters in order to achieve the constraints of the video system, needs, or desires of the entity operating the video system.

The method can further include sending the video newsletter to the user device. In one embodiment, the video newsletter can be sent in accordance with the schedule, and in another embodiment, the video newsletter may be sent at nearly any time after it is received by the data processing system 220. In a particular, non-limiting embodiment, sending the video newsletter can include sending a VOD unicast stream to the user device over a television channel, wherein the VOD unicast stream is associated with the video newsletter, at block 542 in FIG. 5. One or more other particular methods (e.g., using a multicast stream) may be used. The video newsletter may be viewed by the user after it is received by the user device 262 or 264. In one embodiment, the video newsletters may be viewed at the user device 262 or 264.

In another embodiment, the method can include recording the video newsletter on a recording device of the user device, at block 562 of FIG. 5. The processor of the user device 262 or 264 can determine whether the video newsletter is to be viewed, recorded, otherwise dispositioned, or any combination thereof. The determination may be based on whether the television monitor of the user device 262 or 264 is on, metadata within the video newsletter (e.g., metadata may include an instruction or a flag that can be read by the processor), another criterion, or any combination thereof.

The method can further include displaying a message that the video newsletter has been recorded, at block 582 in FIG. 5. The message may be sent by the processor and displayed on the television monitor of the user device 262 or 264 before, during, or after the video newsletter is recorded. In a particular embodiment, the television monitor or other portion of the user device 262 or 264 may be off or in an inactive state when the recording occurs. When the user turns on the television monitor or when the portion of the user device 262 or 264 becomes active, the processor may then send the message to the television monitor. The user may or may not then elect to view the video newsletter at that time.

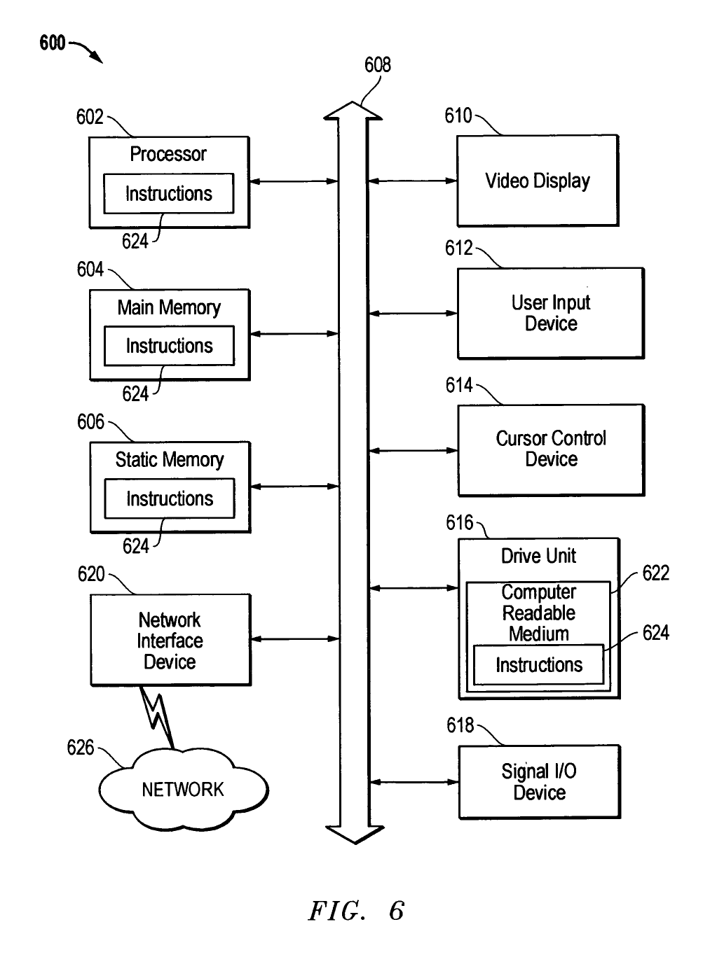

Referring to FIG. 2, the interactive content source 202, the broadcast content source 204, the data processing system 220, the user device 262 or 264, another device (not illustrated), or any combination thereof can include a computer system. FIG. 6 includes an illustrative embodiment of a general computer system and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a desktop or laptop PC, a tablet PC, an STB device, a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (“CPU”), a graphics processing unit (“GPU”), or both. Moreover, the computer system 600 can include a main memory 604 and a static memory 606 that can communicate with each other via a bus 608. As shown, the computer system 600 may further include a video display unit 610, such as a liquid crystal display (“LCD”), an organic light emitting diode (“OLED”), a flat panel display, a solid state display, or a cathode ray tube (“CRT”). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. The computer-readable medium 622 is an example of a data processing system readable medium. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

Embodiments described herein can allow a user at a user device to interact with interactive content in a manner similar to the way they would on the Internet without the limitations of the Internet. Some interactive content that may not be available over the Internet, due to its limitations, may be available only to user devices connected to the data processing system of the television content service provider. For interactive content available over the using the television channel and the Internet, the quality of the content (e.g., resolution, transmission rate, etc.) from the television channel may be better. Compromises for different connections, etc., which may occur with interactive content over the Internet may be substantially eliminated because the television service provider, rather then the user devices, can set parameters that ensure repeatable, known quality of service.

The user at the user device can determine the depth and length of information that the user desires to retrieve. For example, a user can get product information and pricing of the product very quickly, such as in less than a minute. The user does not need to view over 20 minutes of a 30-minute commercial to get the same information. In addition, the interactive content allows the user to explore information that the user desires. For example, the user may be interested in detailed specifications of the product. A commercial is typically designed for a general audience and not an individual user. Detailed information, such as the detailed specifications, may not even be part of the commercial. The user may have many alternatives to view different product configurations, send a message to the entity that provides the product, arrange a test, or the like. Much of the description herein can also apply to a service instead of or in conjunction with a product. The actions requested by the user may occur without the user changing a television channel.

The interactive content can be provided over a private network, as opposed to a public network, such as the Internet. The private network can allow secure communications and can substantially eliminate problems associated with worms, viruses, or other destructive code that can migrate over a public network. The user does not need to obtain and frequently update protective software, such as a firewall, antivirus software, or the like. Thus, the user can save time and money. After reading this specification, skilled artisans will appreciate that, although a private network may provide benefits to a user, a private network is not to be construed as an essential or critical feature.

Users can keep up to date with information regarding products and services by opting into subscription video newsletters. The video newsletter can be sent by the television content service provider that is automatically received by user devices in accordance with a subscription list. The video newsletter can be viewed by a user substantially in real time or may be recorded. The recording can be transparent to the user. The user may be prompted with a message that a new video newsletter has been received. The type and quality of content in the video newsletter can be different than what can be achieved by a printed newsletter or a video newsletter transmitted over the Internet.

The video system can be configured so that use of the user device with the interactive content is similar to using broadcast content. The same remote control can be used for broadcast content and interactive content. The navigation can be easier and simpler compared to browsing the Internet. A keyboard or mouse may not be required. Menus used in making selections may be shorter and simpler.

Although the number of television channels over which the interactive content may be broadcast is significantly more limited than the number of domain names that can be used for interactive content on the Internet, entities with large marketing budgets or more complicated products or services may desire the ability to use a television channel to transmit interactive content. Such entities can provide a more professional looking source of information, and potentially provide interactive content that would otherwise not be available.

Note that not all of the activities described above in the general description or the examples are required, that a portion of a specific activity may not be required, and that one or more further activities may be performed in addition to those described. Still further, the order in which activities are listed is not necessarily the order in which they are performed.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of using a video system, the method comprising:
receiving broadcast content via data packets over a first television channel; and
receiving interactive content via data packets over a second television channel that is different from the first television channel.

2. The method of claim 1, further comprising:
selecting the second television channel before receiving the interactive content; and
processing the interactive content using a television tuner after receiving the interactive content.

3. The method of claim 1, further comprising sending a request for the interactive content, wherein:
the request includes a search string, and the interactive content includes information associated with the search string;
the request includes a request for a video segment associated with a product or service, and the interactive content includes the video segment;
the request includes information associated with a product configuration, and the interactive content includes a video image associated with a product having the product configuration;
the request includes a request to schedule a test of a product or service, and the interactive content includes a confirmation associated with the test; or
any combination thereof.

4. The method of claim 3, wherein receiving the broadcast content, sending the request, and receiving the interactive content is performed using a private network.

5. The method of claim 1, further comprising sending a communication associated with opting into a subscription video newsletter, wherein receiving the interactive content comprises automatically receiving a video newsletter associated with the subscription.

6. The method of claim 5, wherein receiving the interactive content comprises receiving a video-on-demand unicast stream over the second television channel, wherein the video-on-demand unicast stream is associated with the video newsletter.

7. The method of claim 5, further comprising recording the interactive content on a digital video recorder.

8. The method of claim 7, further comprising displaying a message that the interactive content has been recorded.

9. The method of claim 1, wherein:
the broadcast content is broadcast substantially in real time at a predetermined time; and
the interactive content is substantially promotional content associated with a product or a service.

10. The method of claim 1, wherein the interactive content comprises a user-selectable element that is embedded within the interactive content, wherein the user-selectable element is associated with a request to modify the interactive content or obtain new or different content from a television content service provider while remaining at a television channel.

11. A data processing system readable medium having data embodied within the data processing system readable medium, the data comprising:
an instruction to send broadcast content via data packets over a first television channel to a user device; and
an instruction to send the interactive content via data packets over a second television channel to the user device, wherein the second television channel is different from the first television channel.

12. The data processing system readable medium of claim 11, wherein the instruction to send is executed in response to receiving a request from the user device for the interactive content, wherein:
the request includes a search string, and the interactive content includes information associated with the search string;
the request includes a request for a video segment associated with a product or service, and the interactive content includes the video segment;
the request includes information associated with a product configuration, and the interactive content includes a video image associated with a product having the product configuration;
the request includes a request to schedule a test of a product or service, and the interactive content includes a confirmation associated with the test; or
any combination thereof.

13. The data processing system readable medium of claim 12, wherein:
the instruction to send the broadcast content comprises an instruction to send the broadcast content over a private network;
the request is received from the private network; and
the instruction to send the interactive content comprises an instruction to send the interactive content over the private network.

14. The data processing system readable medium of claim 11, wherein the data further comprises an instruction to schedule a video newsletter to be sent to the user device, wherein:
the instruction to schedule is executed in response to receiving a communication from the user device, wherein the communication is associated with opting into a subscription video newsletter;
the video newsletter is associated with the subscription; and
the instruction to send the interactive content comprises an instruction to send a video-on-demand unicast stream to the user device over the second television channel, wherein the video-on-demand unicast stream is associated with the subscription video newsletter.

15. The data processing system readable medium of claim 14, wherein the instruction to send comprises an instruction to send the interactive content over a private network.

16. The data processing system readable medium of claim 11, wherein:
the broadcast content is broadcast substantially in real time at a predetermined time; and
the interactive content is substantially promotional content associated with a product or a service.

17. The data processing system readable medium of claim 11, wherein the data further comprises an instruction to modify content received from an interactive content source to form the interactive content.

18. The data processing system readable medium of claim 11, wherein the interactive content includes a user-selectable element that is embedded within the interactive content, wherein the user-selectable element is associated with a request to modify the interactive content or obtain new or different content from a television content service provider while remaining at a television channel.

19. A data processing system comprising:
a request receiving module;
an interactive content transmission module adapted to transmit interactive content over a television channel to a user device, wherein the interactive content includes data packets; and
a video-on-demand server coupled to the interactive content transmission module, wherein the video-on-demand server is configured to retrieve and send the interactive content to the interactive content transmission module, and wherein the interactive content is associated with the request.

20. The data processing system of claim 19, further comprising a content modification module to modify content received from an interactive content source to generate the interactive content, wherein the interactive content has a different data format, a different transmission quality, a different display quality, or any combination thereof, as compared to the content received from the interactive content source.

21. The data processing system of claim 19, wherein the interactive content transmission module is configured to retrieve a subscription list and to transmit the interactive content to an address within the subscription list.

22. The data processing system of claim 19, further comprising a broadcast content transmission module to transmit broadcast content including data packets, wherein the broadcast content transmission module can transmit independently from the interactive content transmission module.

23. The data processing system of claim 19, wherein each of the interactive content transmission module and the broadcast module is configured to transmit the interactive content and the broadcast content, respectively, using Internet Protocol.

24. The data processing system of claim 19, further comprising a storage device, wherein the interactive content is organized into different hierarchical levels of information within the storage device.

25. The data processing system of claim 19, wherein the interactive content transmission module is configured to transmit the interactive content that can include a user-selectable element that is embedded therein.
